(19) United States
(12) Patent Application Publication
(10) Pub. No.: US 2008/0310736 A1
(43) Pub. Date: Dec. 18, 2008

(54) SMART VISUAL COMPARISON OF GRAPHICAL USER INTERFACES

(75) Inventors: Amit Chattopadhyay, Chennai (IN); Gautam Goenka, Hyderabad (IN)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/763,711

(22) Filed: Jun. 15, 2007

(51) Int. Cl. G06K 9/68

(52) U.S. Cl. 382/218

(57) ABSTRACT

The subject disclosure pertains to systems providing a smart visual comparison system, comprising a data compilation component that gathers control information relating to a first image and a second image, and a comparison component that identifies elements represented in the first and second image and compares the elements in the first image to elements in the second image. The system can compile the differences between elements and provide differences between the elements. The system can present only crucial differences to a user, resulting in an elegant comparison system. The user can input tolerance information to define crucial differences, to fit a particular case.

### BACKGROUND

Today's economy relies on software. Virtually all organizations from businesses and universities to hospitals and governments depend on software in almost every facet of their operations. Consequently, there is an increased demand for powerful software that is easy to use. At present, there is no sign that this trend will diminish, so it is becoming increasingly important for software producers to develop and test software quickly, accurately, and efficiently.

While many aspects of software production has been automated, most code is initially written manually by a programmer typing computer code at a keyboard terminal. As any programmer knows, bugs are an annoying but ubiquitous and unavoidable part of the software making process. Many automated tests and debuggers can assist detection, diagnosis, and elimination of bugs in software, but it is good practice to test software manually in addition. However, the expertise, time and manpower required for manual testing makes up a considerable component of the cost of software development. Also, manually testing software can prove to be tedious to such a degree that perfect testing by such methods is impossible.

Software is not simply written and compiled; rather, it is created by an evolutionary process from the alpha stage (initial development), to the beta stage (ready for testing, but not for retail sale), to the gold stage (ready for store shelves and retail download). Each stage may feature various builds or other iterative releases. While this terminology may differ between various software producers, the process is largely similar. One particular difficulty presented by this iterative, step by step process, is detecting differences from one build to the next. Further, given the multiplicity of platforms, operating systems, and environments of today's computing world, running the same piece of software on different machines can produce different results that are difficult to detect. There is a need to increase the detection and resolution of these changes in software as it progresses through the evolutionary process that is reliable and manageable.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure concerns a smart visual comparison system that can receive a pair of images and compare them for differences using not only graphic information, but control information relating to the functionality and operation of elements represented in the images. The images can be any type of image where comparison between the two is needed, including but not limited to screenshots of a user interface. A data compilation component can gather graphic information as well as control information from the image itself, or from another entity controlling and operating the image. The data compilation component can then create an object map file containing the elements in the images as well as the control information relating to the elements.

A comparison component can receive the object map files and make a comparison of elements in the two images, based in part upon the graphic information and the control information. The comparison can identify elements that are completely matched in both images, elements that are partially matched, and elements that are completely different. Completely matched elements need not be identical—they may only have some set of core properties in common. Partially matched elements can be elements identified by the comparison component as the same element in both images, altered somehow in one of the images. Partially matched elements can be further broken down into elements exhibiting crucial differences and those exhibiting non-crucial differences. Crucial differences can be displayed to the tester, while non-crucial differences can be hidden from view. The tester can set forth a definition of a crucial difference by identifying a set of properties of the elements that, if changed, constitute a crucial difference.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a smart visual comparison system, showing graphic information and control information relating to an image, a data compilation component, and a comparison component.

FIG. 2 is a block diagram showing operation and interaction of a comparison component, an artificial intelligence component, an optimization component, and a data store.

FIG. 3 is a block diagram of further operation of the comparison component, including designating elements as matched, partially matched, removed, or added.

FIG. 4 is an illustrative user interface implementing the subject system, showing a three pane window to facilitate visual comparison of images.

FIG. 5 is an illustrative window showing display options presented to a tester.

FIG. 6 is a block diagram of inputting tolerance information to a smart visual comparison system, including moving a slider to include or exclude certain properties of elements represented in an image.

FIG. 7 is a block diagram of inputting tolerance and preference information to a smart visual comparison system, including selecting certain properties pertaining to elements represented in an image.

FIG. 8 is a flow chart diagram of a methodology for comparing two images according to control information and graphic information.

FIG. 9 is a flow chart diagram of a methodology for comparing two images and testing a test case for functionality.

FIG. 10 is a schematic block diagram illustrating a suitable operating environment.

FIG. 11 is a schematic block diagram of a sample-computing environment.

### DETAILED DESCRIPTION

A smart visual comparison system is provided whereby a comparison of two images can be compared analytically. The two images can be screenshots of a user interface, or any other pair of images to be compared. As described, the two images can be compared using both graphic information as well as control information and metadata. The control information can enhance the information known about an image beyond simple graphic information. Elements represented in the image such as buttons, lists, text boxes, lists, radio buttons, and the like, can be identified for their functionality rather than just for their aesthetics. Using this control data, the elements can be compared for differences, which can then be represented to a tester for easy identification and resolution.

In one embodiment, the two images comprise screenshots of a user interface taken at successive stages of development of the software. The software development process is iterative and lengthy, and many details that require attention to produce a seamless, polished look to a user interface. As the software develops, elements may change, and previous methods of detecting theses changes have proven unworkable. Many manual testing methods require the tester to look at two images and identify minute changes to the elements on the screen with the naked eye—a daunting task given today's complex software can include thousands of screens, requiring a Herculean effort to manually test each screen against its predecessor for changes. The inventive system mitigates this problem by using control information about elements in the user interface, comparing the elements in an automated manner, and presenting the results to the tester for his review and approval. Examples of control information include text value, size, location, automation name, and control parenting. It is to be appreciated that the preceding list of examples should not be taken to limit the subject system, and that control information can comprise a wide variety of information relating to operation of software. In one aspect, the two images can be shown side-by-side, and the differences highlighted. This makes it easy for the tester to spot changes, even minute changes such as a font size substitution, or an element that may have moved only one pixel from the first image to the next. In another aspect, the differences can be displayed in a list. The tester can choose whether to view all elements, or only the elements that are different between the first and second image.

By way of example, suppose a new build of a software product has recently been finalized, and is ready for testing. The subject system can capture an image representing screenshots of the new build that requires testing. The system can extract graphic information and control information from these images, and along with screenshots taken during the last build, compare each image pair. Suppose a button on a window of a user interface has been moved from the bottom right of the image to the bottom left. In addition to being detectable to the human eye, the change in placement of this button can be described in the control information, and therefore reported to the tester. In this way, the tester does not have to rely on his own eyes alone to detect the change, rather, the change is presented to him in a conspicuous way. After all, most changes are subtle, and are not as easy to detect as this example. As a result, the testing process is much more reliable and easily performed than previous testing methods. By easing the tester's task, the subject system increases the likelihood that the test will be carried out at all, because if the task of testing software manually is too difficult or tedious, the human tester may simply skip the task altogether.

Not all changes are of the same magnitude, especially at different stages of the development. Early on, the tester may be concerned with functional changes—in an effort to create a functioning version—whereas toward the end of the development, the tester may be concerned with polishing the user interface by unifying the size of elements, the fonts, the colors, etc. Regardless of the issues the software development may be presently facing, the tester will likely be concerned with some differences, but not others. Previous methods are unable to differentiate between what is an important difference, and what is merely noise. In an aspect, the subject system can present differences deemed important, while withholding those differences that are merely noise. This dramatically reduces the time and effort required of the tester, resulting in reduced testing times and improved reliability. In another aspect, the tester can indicate which differences are considered crucial, and based on this information, the system can display or hide differences. This customizability greatly enhances the utility of the subject system because of the flexibility it affords a testing operation.

In another embodiment, the subject disclosed system can be used to identify portions of the source code that may relate to the changes between the two images. Frequently, computer programmers and testers utilize test cases, which are small snippets of code used to test and debug a portion of code. In software engineering, the most common definition of a test case is a set of conditions or variables under which a tester will determine if a requirement upon an application is partially or fully satisfied. It may take many test cases to determine that a requirement is fully satisfied. In order to fully test that requirements of an application are met, there must be at least one test case for each requirement unless a requirement has sub requirements. In that situation, each sub requirement must have at least one test case. The test cases, in essence, put a portion of the source code through its paces, and are used to draw out bugs or other flaws in the software. Due to alterations in the source code, any number of test cases may “break” from one build to the next. In one aspect of the disclosed system, the control information can indicate which test cases relate to which elements of the images being compared, and hence indicate which portions of the source code (or changes thereto) may have contributed to the difference in elements. This embodiment eliminates the tedious and sometimes impossible task of identifying which test cases are broken, and what caused the break.

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

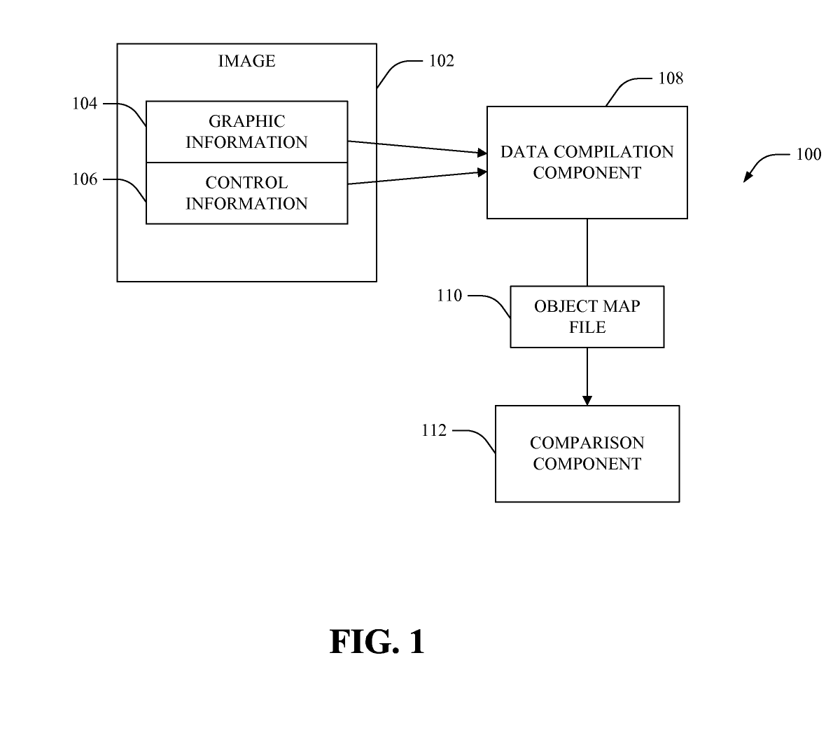

Now moving to the figures, turning initially to FIG. 1, an illustrative interaction 100 of components according to the subject disclosure is shown. An image 102 can contain an image file of any type, and can be the subject of comparison between itself and another image (not shown). The image 102 can contain graphic information 104 referring generally to the pixels actually displayed on the screen. The image 102 also can contain control information 106 relating to the functionality of each element of the image 102. Control information 106 can contain a description of the data that a particular element is designed to receive, the type of data the element can receive, what the element does with the data, what format of data the element can receive, and so forth. For example, graphic information 104 for a portion of the image 102 can be the pixels of a text field (e.g. a black box with a white center), where the control information 106 indicates that the element is a text field (not a combo box, radio button, etc) and receives text from the keyboard when highlighted, and that information should be stored as the user's last name. This information can be extracted by a data compilation component 108 and output into an object map file 110, in a format that can facilitate comparison between this object map file 110 and another object map file pulled from another image. The comparison component 102 can receive this and other object map files 110, and perform the comparison.

The data compilation component 108 can receive the source code for the software, and from it, extract the control information 106. Alternatively, the data compilation component 108 can send requests to the operating system relating to the control information. That is, the data compilation component 108 can actively seek out the control information 106, or it can observe the operation of the software and record the functioning of the several elements and create the control information 106 therefrom. For example, a piece of software, or a portion of the code, can be passed to the data compilation component 108, and without executing the software in the normal sense, the control information 106 can be gleaned from the code of the software. In addition, the data compilation component 108 can execute the software by running the program, or compiling the code, as would be performed normally during use of the software, and observe and record the functioning of the software and thus create the control information 106.

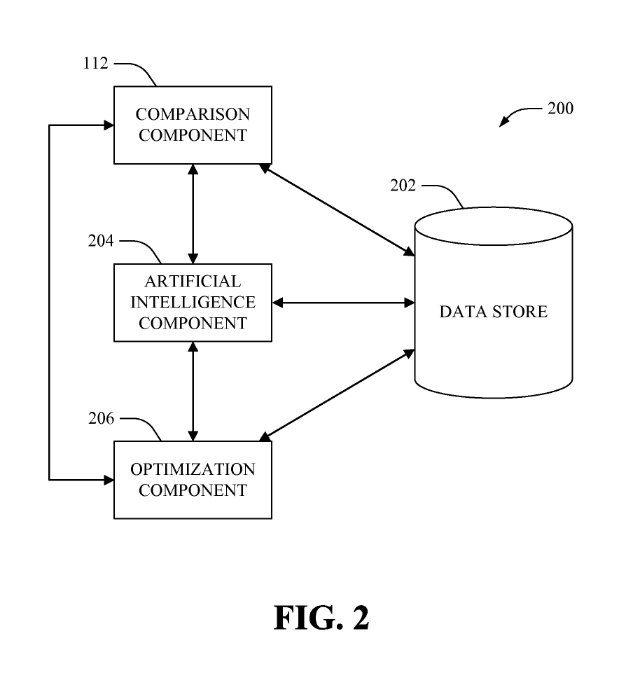

Next, in FIG. 2, an interaction 200 between several components and a data store is shown. An artificial intelligence component 204 can be employed to facilitate the smart visual comparison. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

During the development process as features or elements are added, removed, or altered, it is possible for the software to change to a point that the original goals of the developer are not met, or at least not met with as much force as the developer anticipated. To prevent this, the artificial intelligence component 204 can store developer goals, which can be over-arching, high-level ideas that the software should strive to reach. The artificial intelligence component 204 can ensure that these goals continue to be met in the haze of so many details of the software development. For example, a developer goal may be to keep a user interface simple and clean by having fewer than a set number of words appear on any one page. This, to prevent an intimidating prolix block of text, or a forest of options that may confuse the user. If a difference detected by the comparison component exceeds this limit, the artificial intelligence component 204 can take note of the fact, and take appropriate action to remedy the situation. The difference can be flagged as crucial and presented to the user with a message indicating that there is too much text on the screen, or any other appropriate action that would prevent the unwanted difference from persisting in the software. To perform these tasks, the artificial intelligence component 204 can interact with an optimization component 206, which can also access developer goals and instruct the tester regarding how to better accomplish the goals.

The comparison component 112, the artificial intelligence component 204, and the optimization component 206 can all interact freely with one another as needed. They can also communicate with the data store 202 to store and retrieve information accordingly. The data store 202 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The data store of the present systems and methods is intended to comprise, without being limited to, these and any other suitable types of memory.

In another embodiment, the subject system can be employed to organize and store digital photographs or other images taken with a digital camera. The artificial intelligence component 204, in conjunction with the optimization component 206 can rank, or order, a set of images according to a set of rules. The rules can relate to producing the best photograph under a given set of conditions, or according to user preferences, observed and recorded over time. For example, a given user may have a preference for photographs with high contrast and many shadows. This preference can either be explicitly entered, or it can be inferred from the user's actions such as printing more high contrast photographs than low contrast photographs, deleting photographs with low contrast, etc. With a satisfactory set of rules in place, the artificial intelligence component 204 can receive a comparison between a pair of images from the comparison component 112, and based on the differences, rank one photograph higher than the other. The same process can be repeated until all photographs are ranked in order of preference, first to last. The user of this system, when it comes time to review the photographs, can thus be presented with his favorite photographs first, leaving other photographs for later.

In another aspect, the subject system can eliminate duplicative photographs. In contrast to film cameras, where every snap of the shutter produces a print, and brings the photographer one step closer to needing a new roll, digital photographers face no penalty for taking more photographs than needed to ensure the best photographs are taken. This has led to most amateur photographers—and even some professional ones—to simply snap photographs at will, without regard to the consequences. In addition, many cameras feature a rapid-fire or time-release mode where a multiplicity of photographs are taken in a matter of seconds. As a result, photographers are faced with the difficult task of choosing between several photographs for the best one. Also, even though digital memory and storage is continually becoming more affordable, there has been a corresponding increase in the size of each photograph taken. Today's seven and eight mega-pixel cameras can easily fill up a large memory device with photographs ranging from a few to several megabytes each.

The subject disclosure allows for eliminating duplicative photographs by making a comparison between several photographs, noting the differences between them, and if there are no notable differences, keeping the best photograph, and deleting the rest. Notable differences can depend on user characteristics, preferences, and other indicia gathered explicitly from the user, or implicitly by observing habits and behavior. Alternatively, the duplicative photographs can be moved to another storage location where memory is not at such a premium. This same process can streamline a set of time-release photographs. A good time-release shot progression can capture a slow moving object, but conventional systems simply release the shutter at pre-determined intervals. According to the subject system, the first image can be taken at the incipience of the shot. This image can serve as the first image, against which subsequent images are compared by the comparison component 112. The second image can be the live shot, before being recorded as a photograph. Once the subject of the shot moves or changes sufficiently (according to the tolerances) the differences may be characterized as crucial, at which point the image can be captured as the next photograph in the sequence, and used to compare against subsequent images. Therefore, time-release shot progressions can eliminate intermediary, duplicative photographs, where the definition of duplicative can vary according to user preferences, explicit and implicit.

As an example of the foregoing explanation, suppose a time-release of a flower in bloom. The nature of digital photography allows the subject disclosure to capture a near perfect time-release image progression of the blooming flower. A first image can be taken to initiate the progression. The image can be of the flower, with no petals or color appearing, motionless. The digital camera records this first image into memory as a photograph. The camera will continue to, in essence, take several more photographs. However, these are not recorded as photographs, rather they are shown in a viewfinder as a series of successive frames, much like a movie. Each frame can be analyzed for differences by the comparison component 112, and if and when the threshold difference arises, that frame is taken as the next photograph and recorded in memory, and used against which to compare other frames. Suppose the flower begins to bloom, triggering a second photograph, and the process repeats. The control information 106 can relate to color differences, enabling easy capture of the first moment a brilliant red petal emerges from its green casing. Each analysis may take some time, if only a few nanoseconds. However, if the subject of the photograph moves so much that each frame comprises sufficient differences that each will be taken as a photograph, the analysis can be suspended, and revert back to pre-determined intervals. In the alternative, a maximum amount of difference can cause the camera to suspend taking the next picture in the series. If the flower, normally still but blooming ever so slightly, is blown by a gust of wind, rather than capture the erratic movement, the comparison component 112 can instruct the camera to wait until the wind has subsided to take the next shot. The result is a time-release progression without erratic movement, representing a smooth, gracefully blooming flower.

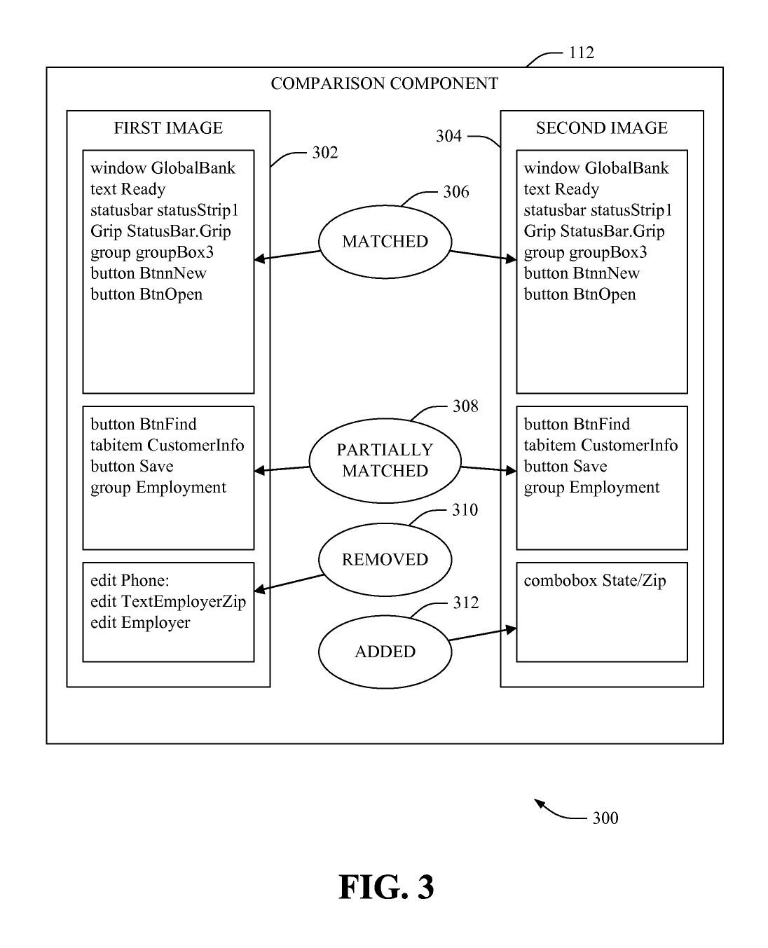

Proceeding to FIG. 3, further operation 300 of the comparison component 112 is shown. The column on the left represents objects found in the object map file of the first image 302, and the column on the right pertains to objects of the second image 304. The comparison component 112 can identify matched elements 306, which can be elements that have not changed. Matched elements 306 need not be completely identical; rather, a certain set of core properties is shared in the first image 302 and the second image 304. This allows the comparison component 112 to eliminate these elements from presentation to the user. Doing so will reduce the amount of information given to the user during the comparison, which may reduce the amount of time and effort required to test the software dramatically.

Next, the comparison component 112 can identify partially matched elements 308, which can be elements that are different but related. For example, a combo box labeled “Employer” in the first image 302 and a text box labeled “Employer” in the second image 304. These two elements are not identical, but they likely represent the same element in both images, only changed from a combo box to a text box. This is a type of functional difference that may be more easily detected by obtaining the control information (e.g. element 106 in FIG. 1) relating to an image. This difference may not be detectable to the naked eye (such as in a manual test), but can be clearly revealed by looking at the underlying control information. Removed elements 310 can be those present in the first image 302 and not present in the second image 304, and added elements 312 can be those elements not present in the first image 302 and present in the second image 304. The elements listed in the two columns are for illustrative purposes only, and do not limit the scope of the subject disclosure to the elements listed in any way.

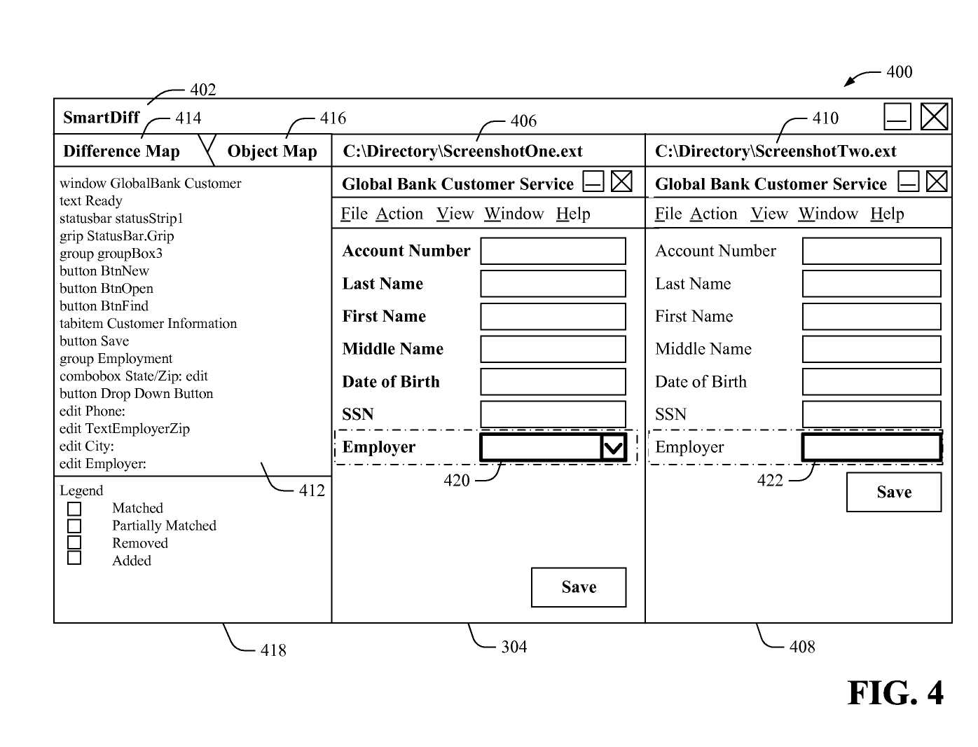

Moving on to FIG. 4, a system for smart visual comparison 400 is shown. The comparison shown is merely for illustrative purposes, and the form and layout of the windows represented in FIG. 4 should not limit the scope of the subject invention in any way. FIG. 4 will be described herein from the perspective of software development, with a first and second build of a software product being compared. It is to be appreciated that the principles of the subject disclosure as shown and described can be practiced in any relevant context. FIG. 4 shows a three-pane window 402. Beginning with the middle pane 404, a representation of a first screenshot 406 of one build of a software product is shown. The software product can be at any stage of development. In the illustrative example shown the software is for a bank, and can receive information from a customer such as account number, name, date of birth, and social security number. The second pane 408 shows a second screenshot 410, which may be the same aspect of the software product, only a subsequent build or iteration. The image can alternatively be any image that a tester desires to compare to the first screenshot 406. Previous methods of testing required a tester to simply look at the two images and scour them for differences. Other early methods superimposed the two images to create a hybrid to more particularly draw the tester's attention to the differences. Small, unimportant differences between operating systems, display settings, color schemes, and other trivia, even a difference measured as a few pixels, derails these methods. Also, these early methods did not adequately address the tedium of searching for differences between two images. Comparing two images is tiresome to the eye and error-prone. The problem is compounded by the nature of today's software, in which these screenshots are only two of potentially thousands that need comparing. The sheer number of images that require testing, caused by the size of today's software, demands a more elegant way to compare images.

The map pane 412 can display the information in the object map file as a list of elements present in the first screenshot 406 and/or the second screenshot 410. The selected tab, Difference Map 414, can display elements that are different between the two screenshots. Another tab, Object map 416, can display all elements, without respect to any differences between the screenshots. In this way, the functional differences between the two screenshots can be identified easily in the list presented in the map pane 412. A tester can easily view which elements, if any, have changed between the first screenshot 406 and the second screenshot 410. The differing elements can be indicated with the help of a legend 418, where elements can be indicated either matched, partially matched, removed, or added, as described above with respect to FIG. 3. The legend can utilize a color scheme, or any other applicable method to identify elements as needed.

The first pane 404 shows a number of elements, some of which are different from elements in the second pane 408. In particular, data field “Employer” 420 as shown in the first pane 404 is a combo box, as indicated by the presence of the drop-down arrow at the right hand end of the box. In contrast, the data field “Employer” 422 in the second pane 408 is a simple text box. Depending on the tolerances set by the tester for this test, this element may or may not be highlighted. In this case, the tolerances are set to represent this as a difference worthy of reporting to the tester. The system 400 can draw attention to this difference by bolding and outlining the two elements in both the first pane 404 and the second pane 408, as shown. The system 400 can alternatively shade all other elements so as to draw the eye toward elements 420 and 422. The difference can also be listed in the Difference Map tab 414, and marked appropriately according to the legend 418. In this manner, a tester may easily identify changes between the two screenshots, and take appropriate action to address the change.

While the difference between elements 420 and 422 in the above example is detectable to the naked eye, the subject disclosure can detect differences that are not. This can be accomplished in part by the use of control information 106. The control information associated with a screenshot can report a change that is difficult or impossible to detect with the human eye. For example, a text box may have a limit to the size of the string it can accept, such as a 24 character limit. There is no visual representation of this limit, but it may be recorded in the control data that the limit has change from 24 characters to 36 characters, and that change can be detected by the subject system and reported to the tester.

Another difference between the first screenshot 406 and the second screenshot 410 is that the text of several elements is bold only in the first screenshot 406. While this is a difference, it may not be important to the tester at this stage of development. If this difference is unimportant, it can properly be prevented from reaching the tester's awareness. Effective testing can more properly be achieved by drawing the tester's attention to important differences, while allowing unimportant differences to be suppressed, at least temporarily.

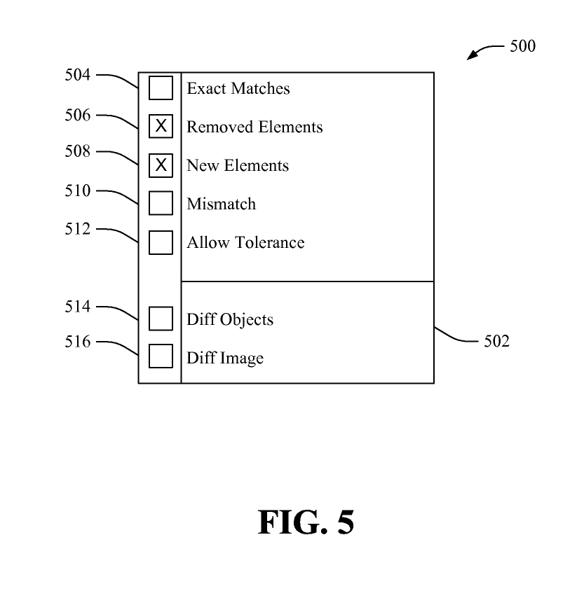

Turning now to FIG. 5, a further aspect of the tester tolerances 500 is shown. A window 502 is shown that contains a number of options for displaying differences to a tester, in the context described in FIG. 4. Each option can be selected or de-selected according to the tester's preferences and the demands of a given pair of images being considered. Generally, the options allow display in the map pane 412, and emphasis in the first pane 404 and second pane 408 of FIG. 4. Exact matches refers to elements that have no appreciable differences between them, from one image to the next. Removed Elements 506 controls display of elements present in the first image and not the second; and New Elements 508 allows display of elements found in the second image and not the first. (These two elements, 506 and 508, are checked in FIG. 5 for illustrative purposes only.) It is possible for an element to undergo such change that is so drastic that it is interpreted by the subject system not as a change, but as a removed and new item in the first 404 and second pane 408 respectively (panes shown in FIG. 4). To mitigate this situation, the system can monitor for paired elements. The tester can check boxes 506 and 508 to browse new and removed items and attempt to reconcile the elements.

Mismatch 510 refers to partially matched elements that the system has judged worthy of display, according to the tester's preferences. The next button, Allow Tolerance 512, toggles display of tester preferences. With this option unchecked, the system can display all detected differences, or only those that meet a default threshold. The last two options Diff Objects 514 and Diff Image 516 allow the tester to alternate between traditional manual testing methods by simply displaying the two images side-by-side for visual comparison. Diff Objects 514 initiates the control information-based analysis as described herein.

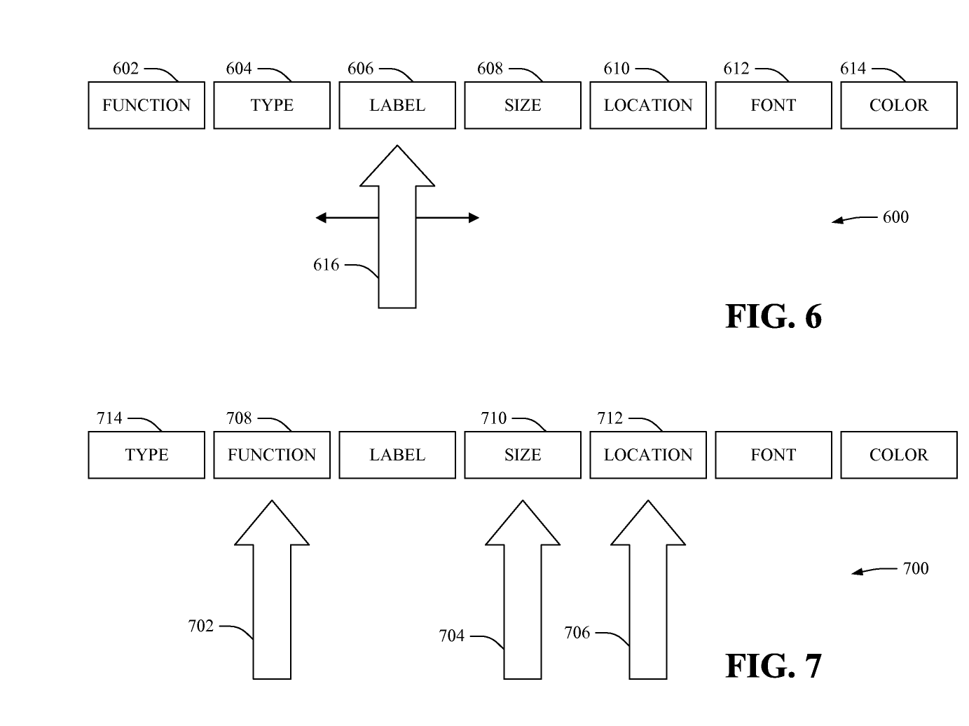

Moving on to FIG. 6, further operation 600 of the comparison component 112 is shown, relating to user tolerance for differences between two screenshots. Function 602 is perhaps the most important aspect of a given element, so it takes the far left position in this illustration. Function 602 refers to the reason the software product includes the element, or what function the element performs. For an element such as a text box, the function may be to receive data, while for a button, the function can be to save the document. Type 604 refers to the means, or implementation of the element. Data receiving elements may be of any type, text boxes, combo boxes, and so forth. While still important to the functionality of the software, this is perhaps a secondary concern. Label 606 refers to how the element is described in the control information or how it is displayed to the user. Because this will affect how data is entered by a user and treated by the system, this is a relatively important feature of an element. Size 608 relates to the size of the element as represented on the screen, whether font size or button size, or any other graphically displayed size of an element. Location 610 describes the physical location of the element on the screen; font 612 refers to font type; and color 614 to the color of an element of components of an element. These descriptors are arranged roughly in order of importance, but because of the widely varying nature of software and software developers, the order may change. This order is given here merely for illustrative purposes. The tester can be presented with these descriptors in order to determine the tester's tolerance for difference. At an early stage of development, a tester may be only concerned that the software continue to function as it should in a subsequent build, so the slider 616 can be positioned under function 602. This way, the comparison component 112 will label elements whose function 602 is different between the first and second screenshot will be displayed to the tester, while lesser important changes such as location 610, font 612, and color 614 may be suppressed because considered “noise.” On the other hand, nearer the final stages of development, the functionality of the software may be complete and bug-free, but it is the user interface that is receiving the test. In this case, the slider 616 can be moved toward the right hand side of FIG. 6, so that all differences to the left of the slider 616 are presented to the tester. Now, testing can be performed on the finer points such as font and color, but still the testing is facilitated because, assuming that major bugs have been addressed, little noise will be present during the test. In this way, if a small change unexpectedly alters the function 602 of an element, this change will be displayed to the tester.

As stated above, matched elements need not be identically matched; rather a set of core properties are shared, so there is no need to display other changes to the tester. Differences between partially matched elements can comprise two types: those that warrant display, and those that do not. In one aspect, those that do not warrant display can be labeled “matched,” to keep from displaying to the tester. In the alternative, these differences can be labeled “partially matched—no display” and “partially matched—display.”

Next, in FIG. 7 a substantially similar tolerance indication system 700 is shown. In this case, the tester can select certain descriptors, and de-select others in order to achieve pin-point accuracy in testing. This is shown by the arrows 702, 704, and 706, indicating that function 708, size 710, and location 712 have been selected, and the remaining descriptors have not. Notice, also, that the position of type 714 and function 708 have changed relatively from their respective positions in FIG. 6. This is to show that the descriptors can be ordered by the user or by the system, or by both, to reflect the current needs of the test. Also, the number and type of descriptors listed in this illustration are for descriptive purposes only; the subject disclosure contemplates using any number or type of aspects to separate differences between images such as screenshots.

The examples described thus far relate to a single software program in various stages of development, but the subject disclosure is not limited to this application. The subject system can be applied to two pieces of software being compared for differences. The two pieces of software can be produced by two different vendors who are competitors, for example. There are many possible applications for comparing software, such as detecting copyright infringement or patent infringement. There are many patents relating to user interface elements, and this tool can automate the process by which copying of crucial elements is detected. Frequently, user interface patents claim subtle aspects difficult to detect with the human eye, so the tools and methods disclosed herein can be used to detect them.

The principles of the subject disclosure can also be applied to detect the functionality of a piece of software on different hardware and/or software combinations. Many programs are written today to run on several different operating systems and environments, each with its own set of parameters for display and interaction. Previously, these differences interfered with the testing process because small, unimportant changes were represented graphically, bombarding the tester with information that is simply noise. The subject disclosed system can be used to identify and cure these small discrepancies, so that the user's experience is uniform across all types of hardware combinations.

Another promising area in which the subject disclosure can be employed is with streaming video. Video information can be represented by a series of successive frames played quickly to appear as a moving picture. Currently, when video is streamed from one computer to another (server to client, or otherwise), a base image is transmitted, and rather than send each successive frame in its entirety, streaming video systems simply send a subset of pixels that are different from the last frame. For example, a video of a newscast with a static background can limit the data transmitted to the pixels representing the reporter who is moving, while not sending information relating to the static background. This reduces bandwidth and allows for larger video files to be transferred and streamed. The subject disclosure can improve streaming video by transmitting control information, in place of or in addition to graphic information, pertaining to the portion of the video that changes from frame to frame.

In another embodiment, the subject disclosure can assist with software testing by indicating which portion of the source code has changed from one iteration to the next. The control information can further include an indication of the source code that controls each element, and if and when there is a change to that element, it can be noted. Software testers frequently employ test cases, small programs designed to test portions of code, to debug and optimize their code. These test cases are said to “break” when the underlying source code is changed without updating the test case, rendering the test case unusable. Frequently, identifying the changes to the source code that cause the test case to break is extremely tedious and difficult. The system of the subject disclosure can include sufficient information in the control information so as to indicate which segment of the source code has changed in connection with a change to an element, leading the tester to an area likely to contain the change that broke the test case. Software development can thereby by simplified greatly by the application of the subject system.

The subject disclosure has, until this point, focused on comparing two images, but it is to be appreciated that any number of images can be compared. In another embodiment, a plurality of image pairs can be analyzed for differences. Each screen in the user interface can be paired with the corresponding screen in the next iteration, and the described system can scan through the pairs until a difference is found—if there is no difference detected under a given set of tolerances, that screen can be withheld from the tester. In this way, the tester may only be shown screens that contain differences that merit the tester's attention.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

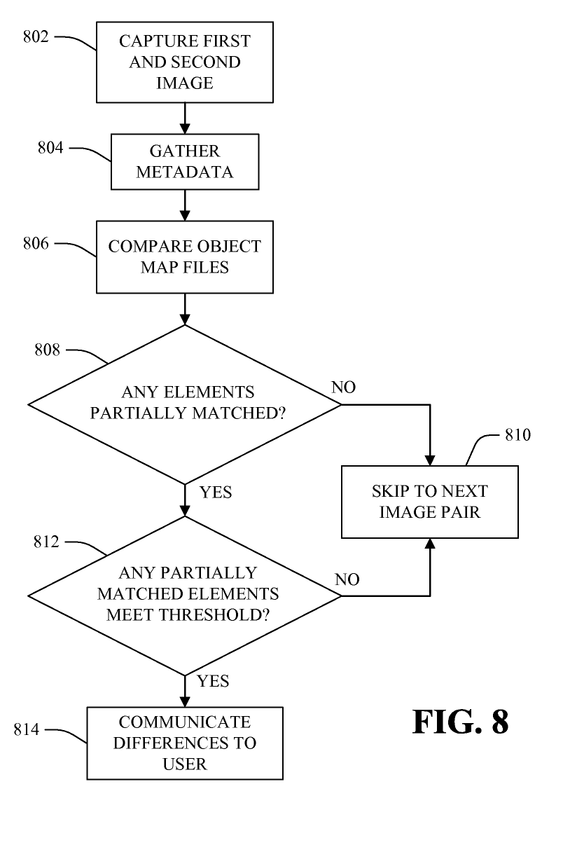

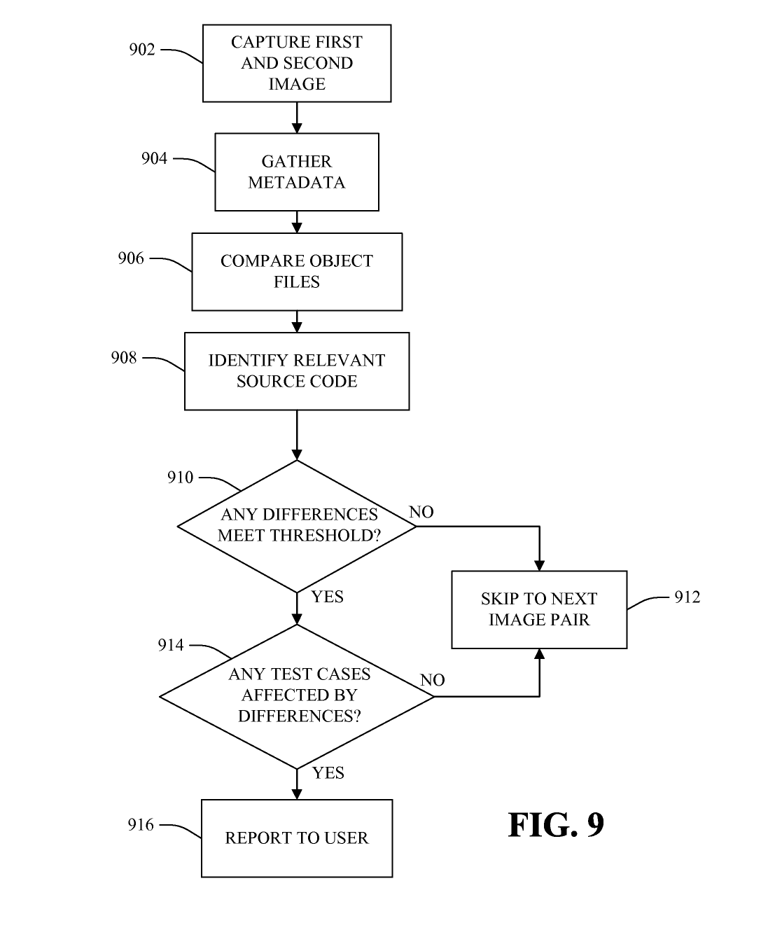

In view of the illustrative systems described supra, methodologies that may be implemented in accordance with the disclosed subject matter will be better appreciated with reference to the flow charts of FIGS. 8 and 9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 8 illustrates a methodology 800 for detecting differences between two images. The images can represent two successive iterations of a software product, or any two images being compared for differences. At reference numeral 802, first and second images are captured. The images can contain a plurality of elements representing a user interface, or other functional elements. Examples of elements are check boxes, text boxes, buttons, combo boxes, and the like. The images can contain control information and other metadata relating to the functionality of the elements. This metadata is gathered at reference numeral 804. The two images can comprise the same software product written for two different operating systems, and therefore the metadata describing the two images can vary between the two images. The methodology 800 can overcome this discrepancy by employing some type of database of different operating system's metadata terminology and labeling schemes. In essence, the system can speak each operating system's language and parse metadata coming from each. Similar techniques can be used to overcome other differences between images across hardware and software diversity.

At reference numeral 806, two object map files, representing the elements in the two images are compared. The object map file can be stored in any format that will facilitate comparison of two elements, including but not limited to the XML format. The files can include metadata and control information included with the images. The object map file can comprise a list of elements, along with graphic information and control information relating to each element. The comparison component can first identify a link between each element and its companion in the other object map file. In the case of no changes, this is an easy task because each element in an object map file can have an identical counterpart in the other object map file. If there are changes, not all elements will be the same, in fact, some elements may change greatly between the two object map files. This changes the comparison component's task from simple matching of identical elements, to requiring some intelligence to determine that two similar elements are the same element. The comparison component can identify core properties of each element, and for purposes of identifying each element and its counterpart in the opposing object map file, can ignore other differences. Core properties can include but are not limited to function, type, relation to other elements, etc. Then, the comparison component can analyze each element and record the differences. If an element is changed so drastically that there are insufficient core properties to identify the element with a match in the opposing object map file, the comparison component can mark the element as removed in the first object map file, and added in the second. Thus, no element escapes the view of the tester.

At reference numeral 808, the comparison component can identify all differences, and create a list of differences that merit displaying to the user, and those that do not. Differences that are unimportant may serve only to distract the user, to the differences are filtered to allow only partially matched elements to be displayed to the user. At reference numeral 808, if there are no partially matched elements, the images are clear of any meaningful differences, and the next image pair is analyzed at 810. If there are partially matched elements, at reference numeral 812, the differences between partially matched elements are evaluated against a tolerance threshold, and if the differences do not meet the required threshold, the next image pair is analyzed at 810. If there are meaningful differences, as determined by user tolerances and preferences, the differences between the first and second images are communicated to the tester at 814. Following this methodology 800 prevents the tester from having to manually filter out meaningless differences between the two images, and allows the tester to focus on the important differences. This makes testing a much more enjoyable experience that is much easier physically on a tester's eyes than previous methods.

Turning now to FIG. 9, a methodology 900 for facilitating diagnosis of test cases is shown. At 902, a pair of images are captured. The images can be screenshots of a user interface taken at different stages of development. These images can contain metadata relating to function of elements represented in the images. A screenshot showing a button, a text box, and a combo box can have metadata describing each element as such. The metadata can also describe how the operating system (or any other entity controlling the operation of the software) handles information passed to and from each element. For example, a text box for data entry can be labeled “name,” meaning that a user is prompted to enter his name in the box, and the text string received from the user is stored as the user's name, and used as needed. This metadata is gathered at reference numeral 904. The metadata can take the form of an object map file which can be used to organize the information in the metadata, and can be stored in a format that facilitates comparison with other object map files. At numeral 906, the two object files are compared for differences. At reference numeral 908 relevant portions of the source code can be identified for their relation to the differences. At reference numeral 910, the differences can be analyzed against a threshold difference level, as indicated by a user, or as observed implicitly. If there are no differences that meet the required threshold, the next image pair is analyzed 912. If there are differences that warrant attention, at numeral 914, the elements exhibiting the differences can be analyzed in comparison to the source code representing the elements. Test cases relating to that portion of the source code can be identified in order to verify whether they remain functional, or have been broken by the changes. Many test cases may remain unbroken, despite a crucial change to the source code, so the test cases can be investigated more fully. Once the broken test cases are identified, they can be reported back to the tester at 916. This methodology can encompass testing the test cases before reporting back to the tester, or simply identifying potentially affected test cases, and allowing the tester to take further action if desired. Using this methodology 900, a tester is not required to hunt down all possible broken test cases by sorting through potentially thousands of tests. This previously unavoidable, and extremely time-consuming and error prone task is eliminated by the subject methodology 900.

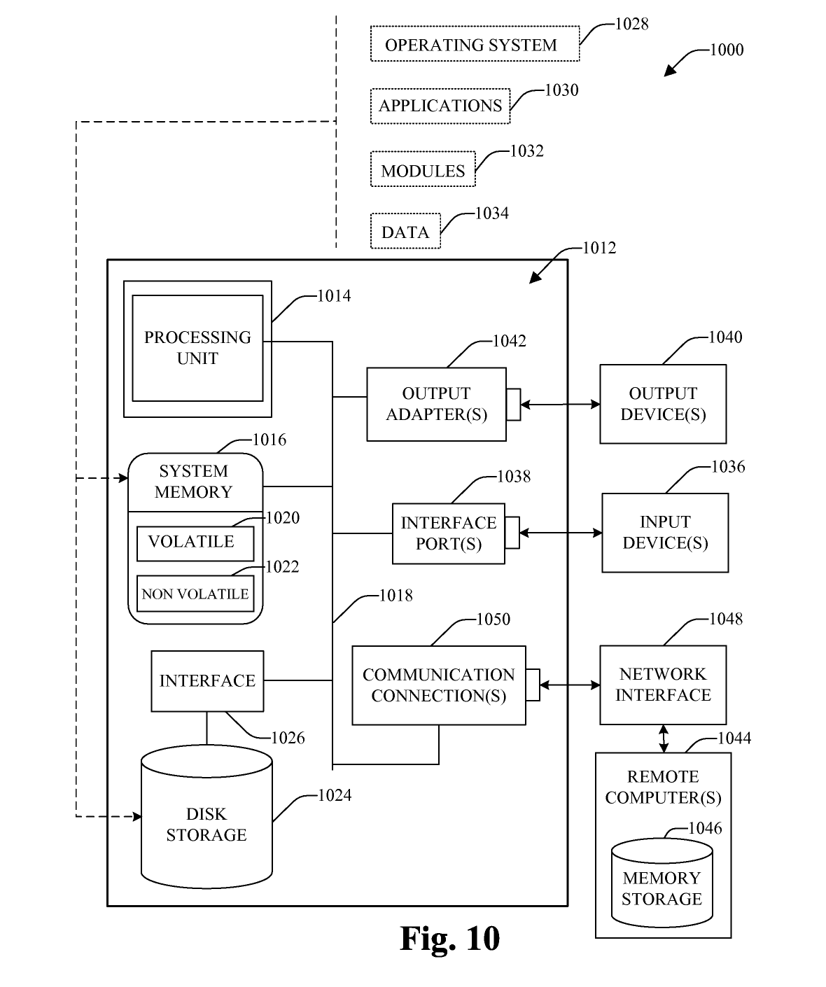

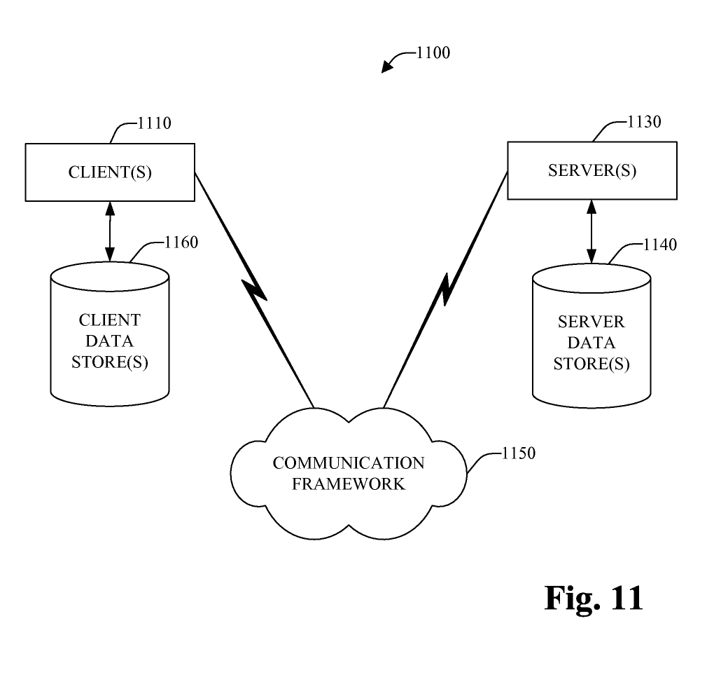

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1000 for implementing various aspects disclosed herein includes a computer 1012 (e.g., desktop, laptop, server, hand held, programmable consumer or industrial electronics . . . ). The computer 1012 includes a processing unit 1014, a system memory 1016, and a system bus 1018. The system bus 1018 couples system components including, but not limited to, the system memory 1016 to the processing unit 1014. The processing unit 1014 can be any of various available microprocessors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like displays (e.g., flat panel and CRT), speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems, power modems and DSL modems, ISDN adapters, and Ethernet cards or components.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the present invention, for example. One possible communication between a client 1110 and a server 1130 may be in the form of a data packet adapted to be transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. A smart visual comparison system, comprising:
a data compilation component that gathers control information relating to a first image and a second image;
a comparison component that identifies elements represented in the first and second image and compares the elements in the first image to elements in the second image and provides differences between the elements.

2. The system of claim 1, at least one of the first image or the second image comprises a screenshot.

3. The system of claim 1, at least one of the first image or the second image comprises a screenshot of a user interface.

4. The system of claim 1, the data compilation component also gathers graphic information relating to at least one of the first or second images.

5. The system of claim 1, the data compilation component gathers the control information from source code responsible for creating at least one of the first or second images.

6. The system of claim 1, the control information comprising at least one of text value, size, location, automation name, or control parenting.

7. The system of claim 1, the comparison component creates an object map file pertaining to at least one of the first or second image, the object map file can be used by the comparison component to compare elements of at least one of the first or second images.

8. The system of claim 1, the comparison component can identify an element as matched, partially matched, removed, or added.

9. The system of claim 8, the comparison component can display partially matched elements to a user.

10. The system of claim 1, the comparison component can provide crucial differences, and withhold non-crucial differences.

11. The system of claim 10, a user can define crucial differences by setting a tolerance relating to the differences.

12. The system of claim 1, the first image comprises an image produced by a first software program, and the second image comprises an image produced by a second software program.

13. The system of claim 12, the first software program and the second software program are produced by different software producers.

14. A method smart visual comparison of a plurality of images, comprising:
capturing a first image and a second image;
gathering control information relating to at least one of the first image or the second image;
identifying differences between elements represented in the first image and the second image using the control information; and
providing a representation of the differences to a user.

15. The method of claim 14, further comprising creating an object map file pertaining to the control information.

16. The method of claim 14, further comprising identifying crucial differences between the first image and the second image, crucial differences can be defined by the user.

17. The method of claim 16, providing a representation of only crucial differences to the user.

18. The method of claim 14, further comprising identifying a portion of source code pertaining to the differences.

19. The method of claim 18, further comprising identifying a test affected by the differences.

20. A system for smart visual comparison, comprising:
means for receiving a plurality of images;
means for gathering control information relating to the plurality of images;
means for comparing elements represented in the plurality of images; and
means for reporting differences between at least two of the plurality of images to a user.
